(19) United States
(12) Patent Application Publication
(10) Pub. No.: US 2025/0316704 A1
(43) Pub. Date: Oct. 9, 2025

(54) METAL AIR BATTERIES

(71) Applicant: AGC CARBON INC., Madison, CT (US)

(72) Inventor: Sumeet Gandhi, Madison, CT (US)

(73) Assignee: AGC CARBON INC., Madison, CT (US)

(21) Appl. No.: 19/174,832

(22) Filed: Apr. 9, 2025

Related U.S. Application Data
(60) Provisional application No. 63/631,619, filed on Apr. 9, 2024.
(60) Provisional application No. 63/690,557, filed on Sep. 4, 2024.

(51) Int. Cl. H01M 4/62; H01M 4/38; H01M 4/66; H01M 12/02; H01M 12/08

(52) U.S. Cl. CPC H01M 4/628; H01M 4/38; H01M 4/661; H01M 12/02; H01M 12/08; H01M 2300/0014

(57) ABSTRACT

A method for designing and implementing a zinc air battery that can be recharged, which involves adding hydrogen gas to the battery, causing it to react with hydroxyl groups in the electrolyte, and then circulating an electrolyte in the presence of a zinc anode to facilitate the recharging process.

### CROSS-REFERENCE TO RELATED APPLICATIONS

This application is also related to U.S. Non-Provisional Patent Application No.______, Attorney Docket No. 126484-840688, filed on Apr. 9, 2025, entitled “CARBON CAPTURE USING SODIUM HYDROXIDE”; U.S. Non-Provisional Patent Application No.______, Attorney Docket No. 126484-840741, filed on Apr. 9, 2025, entitled “LOW TEMPERATURE TRICHLOROSILANE HYDROGENATION”, which claims the benefit of priority to U.S. provisional application No. 63/631,619, filed on Apr. 9, 2024, entitled “ELECTROSYNTHESIS OF TRICHLOROSILANE (USED INTERCHANGEABLY AS TCS OR SIHCL3) USING LOW TEMPERATURE HYDROGENATION OF SILICON TETRACHLORIDE (USED INTERCHANGEABLY AS STC OR SICL4) IN AN ELECTROLYTIC CELL REACTOR WITH CATALYST IMPREGNATED GAS DIFFUSION MEMBRANE AND WITH IR/UV LIGHT ENHANCEMENT” and U.S. provisional application No. 63/690,557, filed on Sep. 4, 2024, entitled “CARBON CAPTURE SYSTEM FOR PRODUCTION OF SODA ASH, BAKING SODA, METHANOL, & FORMALDEHYDE”. All of which are expressly incorporated by reference herein in their entireties.

### BACKGROUND

Metal-air batteries currently face significant implementation challenges primarily centered around recharging difficulties and anode material loss. The formation of chemical byproducts during discharge, such as zinc oxide (ZnO) on a zinc anode surface, makes electrical recharging inefficient and costly, requiring considerable energy to reverse the reaction. This ZnO buildup, along with related problems like dendrite formation, negatively impacts metal-air batteries, rendering the batteries expensive and limiting their lifespan.

Furthermore, metal-air batteries experience a loss of the active anode material during operation due to interaction between the anode and the electrolyte as part of the electricity-generating anodic reaction. This gradual loss of material contributes to reduced overall efficiency and further shortens the battery's operational lifespan. Solutions to these and other shortcomings in metal-air batteries are needed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims

FIG. 1 illustrates an example of a metal-air battery in accordance with some aspects of the subject matter of the present technology.

FIG. 2 illustrates an example of a metal-air battery in accordance with some aspects of the subject matter of the present technology.

FIG. 3 illustrates an example zinc anode of a metal-air battery in accordance with some aspects of the subject matter of the present technology.

FIG. 4 illustrates an example membrane for a metal-air battery in accordance with some aspects of the subject matter of the present technology.

FIG. 5 illustrates an example membrane manufacturing process in accordance with some aspects of the subject matter of the present technology.

FIG. 6 illustrates an example discharge process for a metal-air battery in accordance with some aspects of the subject matter of the present technology.

FIG. 7 illustrates an example recharge process for a metal-air battery in accordance with some aspects of the subject matter of the present technology.

FIG. 8 illustrates an example testing process for a metal-air battery in accordance with some aspects of the subject matter of the present technology.

FIG. 9 illustrates an example of a metal-air battery in a carbon capture system in accordance with some aspects of the subject matter of the present technology.

FIG. 10 illustrates a routine 1000 for recharging a zinc air battery in accordance with one embodiment of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Metal air batteries face challenges with their current implementation. For example, typically, metal-air batteries have the formation of chemical byproducts that make recharging the battery more costly and more difficult. For example, if zinc is used as the anode, a metal-air battery will typically create zinc oxide (ZnO) as the byproduct, which can stay on the surface of the anode. The zinc oxide can also impact the number of recharge cycles available because it leads to the formation of dendrites, which can cause the circuit to short. When recharging the battery, when there is a build-up of zinc oxide, it takes a considerable amount of energy to reverse the reaction and charge the metal-air battery. Because of this increased challenge of recharging a metal-air battery with zinc oxide formation, the resulting metal-air battery leads to an expensive use case.

Further, metal-air batteries suffer from loss of anode material during use. For example, there can be dissolution of the zinc into the electrolyte due to the anodic reaction. When this chemical reaction takes place, the zinc becomes soluble in the electrolyte, causing loss of the anode and reducing the efficiency and lifespan of the metal-air battery.

These issues are especially prevalent when metal-air batteries are integrated into commercial and industrial processes. For example, the integration of the metal-air battery with a carbon capture system allows for the lowest cost of carbon capture while allowing the improved carbon capture systems to stand alone, without the need for external electrical input or upgrades at the customer's facility. Accordingly, addressing the known issues with metal-air batteries will aid in the reduction of greenhouse gasses.

This is an important use case because carbon capture technologies typically capture CO₂ from fuel combustion and other industrial sources to be either pumped into the ground or converted into products that eventually release the CO₂ back to the environment. Different methods of carbon capture have been tried. For example, some carbon capture methods include amine-based systems, absorbent-based systems, oxygen fuel combustion, and solid oxide fuel cells. However, these previous methods can lead to increasing the carbon footprint of the plants where they are installed because they rely on the use of carbon-based power systems, e.g., burning coal for electricity. These systems are not only carbon intensive but also have capital expenditures and increase the operational costs of the plant because they have a large physical footprint that occupies a large portion of the plant or adjacent to the plant and require significant investment in utility upgrades to run the carbon capture systems. Further, these previous systems can produce significant wastewater and other side products, e.g., nitrous oxide, that have increased disposal and treatment costs. An alternate carbon capture system is needed that will reduce a system's carbon footprint, not require large storage additions to the process, and provide the energy source to power and operate the carbon capture system.

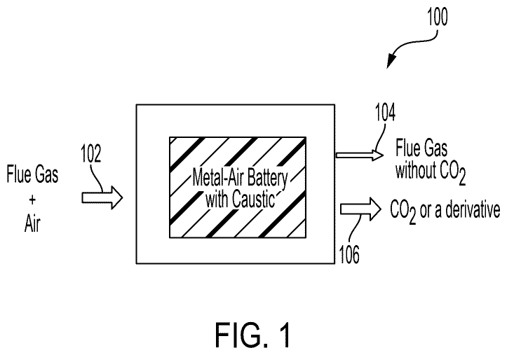

FIG. 1 illustrates an exemplary design of a metal-air battery that is consistent with the present disclosure. The metal-air battery is provided as an example to aid in describing the present technology. Although a particular arrangement of components is depicted in FIG. 1, the arrangement of such components should not be considered limiting of the present technology unless otherwise specified in the appended claims.

A metal-air battery (MAB) 100 of FIG. 1 can be integrated into industrial, commercial, and consumer-facing products. The operation of metal-air batteries typically involves the electrochemical potential derived from coupling metal oxidation at the anode (e.g., using zinc) with the oxygen reduction reaction at a catalyzed air cathode during discharge. Electrons released via the anodic process flow through an external load, delivering power, before being consumed in the cathodic reduction reaction.

The metal-air battery 100 can include a gas inlet 102 that transfers at least air or oxygen into the system. Going forward, the terms “air” and “oxygen” will be used interchangeably. The metal-air battery will also include an electrolyte to carry the charge created during operation. The electrolyte carries the from the anode to the cathode. The air operates as the cathode during discharge for the metal-air battery 100 of FIG. 1. Prior to being transferred into the metal-air battery 100, the air can be conditioned so as to improve the operation of the metal-air battery 100. One example of conditioning the air for gas inlet 102 is that it can be dehumidified through a dehumidification process to remove the moisture from the air prior to it entering gas inlet 102. When the air has too much moisture, it can dilute the electrolyte, and this can change the concentration, conductivity, and other properties of the electrolyte, degrading the performance of the metal-air battery 100. In one example, the metal-air battery 100 can include a gas inlet 102 that is conditioned to be at about 20% humidity. If the air is dry, moisture may need to be added to the gas inlet stream. However, if the gas inlet 102 is too humid, then moisture will need to be removed. It is also possible for the moisture to impact the cathode diffusion layer and/or the cathode current collector. Each of the diffusion layers and current collectors can have the water overwhelm pores, thereby degrading the reaction rate as access to the oxygen is decreased. Finally, moisture can have an adverse impact on the components of the system, including corrosion, causing the premature failure of those components. For these reasons, the air is often conditioned prior to entry into the metal-air battery 100.

Similarly, the air in gas inlet 102 can be treated to remove CO₂, as excess CO₂ can also interfere with the optimal operation of metal-air battery 100. The CO₂ can react with the electrolyte, which will degrade the operation of the metal-air battery 100. This can lead to the depletion of hydroxide ions in the electrolyte, which prevents the electrochemical reactions from taking place. Another consequence of the CO₂ present in the system can be the formation of precipitates, e.g., K₂CO₃ or Na₂CO₃, from the electrolyte. Because precipitates are undesirable in a metal-air battery 100, the CO₂ is preferably removed from the air prior to the air entering the system through gas inlet 102 so that CO₂ concentration is below 10 ppmᵥ.

In operation, the metal-air battery 100 will typically be operating near or at saturation of the electrolyte. In one example, the electrolyte can be 6M lithium hydroxide solution or 6M potassium hydroxide. The electrolyte in its saturated state has a flow rate of from about 0 ml/min up to about 400 ml/min. The metal-air battery can achieve between 0 V to 5 V per cell, and more preferably 0.6 to 1.2 volt per cell during operation. The operation can also be run at between 0 to 10 A. In an exemplary embodiment, the gas inlet 102 can have an air flow between 0 and 4 bar_{g} while having a temperature of between −20° C.-100° C., and more preferably from −20° C. to 80° C.

One solution that is possible is for a metal-air battery 100 to have its own independent loop of electrolyte, air, with a carbon dioxide scrubber, and a feed pump so that the electrolyte and air can be isolated and kept clean to prolong the operating life of the metal-air battery 100. It is also common to include an electrolyte heater to maintain the feed temperature of the electrolyte, e.g., between 0-100° C. when it has its own independent stream.

A further exemplary embodiment of metal-air battery 100 treats the metal-air battery 100 as a fuel cell. The metal anode, e.g., zinc or aluminum, can serve as the source for the fuel cell, while oxygen continuously drawn from the ambient air acts as the oxidant. As metal-air battery 100 discharges, the metal fuel reacts with the oxygen, which can be facilitated by an electrolyte, e.g., KOH or NaOH, to generate electricity, consuming the metal and forming metal oxides or hydroxides as reaction products.

When an anode of the metal-air battery 100 is spent or consumed, one option is for the spent anode to be physically removed from the system and replaced with a new or fresh anode. The spent anode can then be regenerated or renewed via reversing the reactions that cause the anode to be spent. Similarly, the anode can be regenerated or renewed in the metal-air battery 100, via a recharging reaction, as will be discussed in detail below.

Accordingly, metal-air battery 100 is a versatile and clean method for energy production and energy storage.

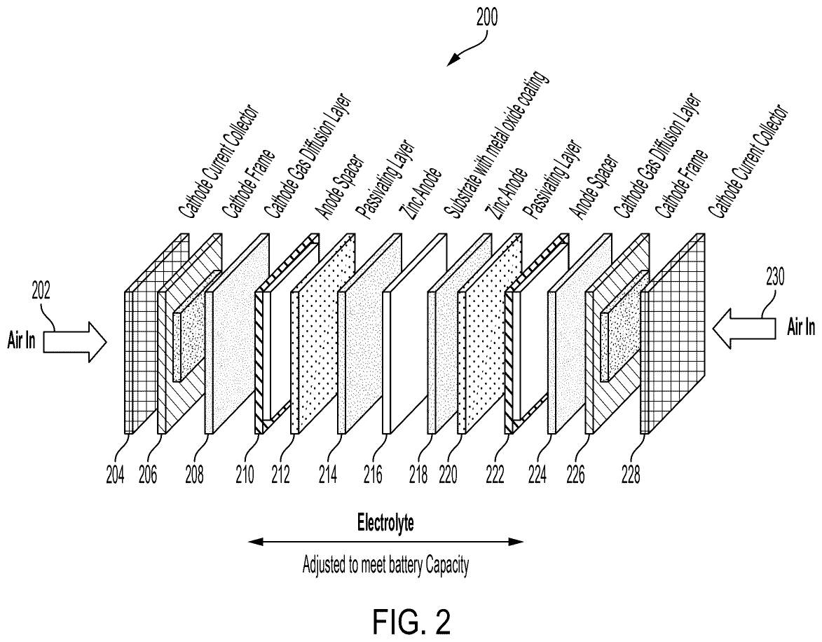

FIG. 2 illustrates an exemplary design of a metal-air battery 200 that is consistent with the present disclosure. FIG. 2 is provided as an example to aid in describing the present technology. Although a particular arrangement of components is depicted in FIG. 2, the arrangement of such components should not be considered limiting of the present technology unless otherwise specified in the appended claims.

In one exemplary embodiment of the present disclosure, the metal-air battery 200 can have cathode current collector 204 and cathode current collector 228 as the outermost layers of the metal-air battery 200, as shown in FIG. 2. The air for the metal-air battery 200 comes into contact with the battery at the cathode current collectors 204 and 228. The cathode current collectors 204 and 228 can be used to distribute the electrical charge that is formed from the anode and facilitate the reduction reaction that occurs at the cathode. The cathode current collectors 204 and 228 can also provide structural support for the metal-air battery 200 and maintain good contact between the anodes and cathodes of a metal-air battery. The cathode current collectors 204 and 228 can also ensure the uniform distribution of the current flows through the electrode to prevent build-up in any one area. This distribution can help increase the lifespan of the electrodes. The cathode current collectors 204 and 228 also provide an interface to provide physical and electrical connections between the metal-air battery 200 and an external circuit. The cathode current collectors 204 and 228 can be made of materials that have longer lifespans in the oxidative environment of the cathode. For example, the cathode current collector can be nickel-based, stainless steel-based, titanium-based, or any other material that can function as a current collector.

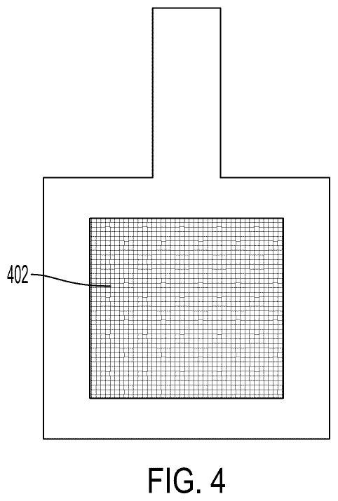

In a further aspect of the present disclosure, FIG. 2 includes cathode frame 206, which helps integrate the gas diffusion layer 208 with the metal-air battery 200, and similarly, cathode frame 226 helps integrate gas diffusion layer 224 into the metal-air battery 200. The cathode frame is designed to secure the gas diffusion layers 208 and 224 between the cathode current collectors 204 and 228 and their respective anodes 214 and 218. The gas diffusion layers 208 and 224 are often porous materials that require structural support, and that structural support can be provided by the cathode frame 206. The gas diffusion layers 208 and 228 can be membrane 402, which will be explained in detail with respect to FIG. 4.

In a further aspect of FIG. 2, the metal-air battery 200 can include a passivating layer 212 and 220. The passivating layers 212 and 220 can form on the anodes 214 and 218 based on the interaction of the electrolyte with the anode or can be added layers adjacent to the anodes 214 and 218. As will be discussed in detail below, the unique chemistry of the current disclosure allows for the minimization of the formation of zinc hydroxide and that it can be more efficiently discharged and recharged. The passivating layers 212 and 220 are adjacent to their respective anodes 214 and 218. The anodes 214 and 218 can be zinc, lithium, or aluminum. Between the two anodes, 214 and 218, can be a substrate with a metal oxide coating, metal oxide substrate 216. The electrolyte is then able to pass between the anodes 214 and 218 and the gas diffusion layers 208 and 224.

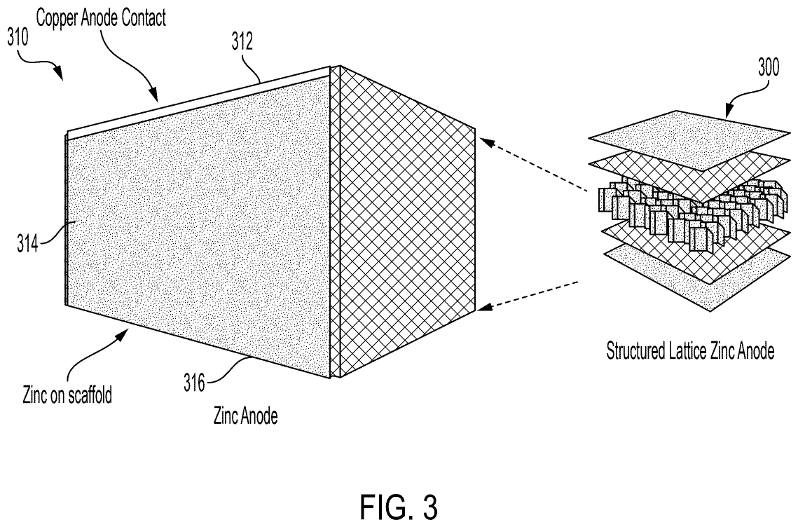

FIG. 3 illustrates an exemplary design of a structured lattice zinc anode 300, that is consistent with the present disclosure. The structured lattice zinc anode 300 is provided as an example to aid in describing the present technology. Although a particular arrangement of components is depicted in FIG. 3, the arrangement of such components should not be considered limiting of the present technology unless otherwise specified in the appended claims.

The structured lattice zinc anode 300 can be used in metal-air battery 200 of FIG. 2 as the anodes 214 and 218 to increase the discharge rate based on the increased surface area of the structured lattice zinc anode 300. Without this lattice structure, the zinc has a low depth of discharge because there is zinc in the anode that is not used during the reaction. This structure of the structured lattice zinc anode 300 can also enhance the rechargeability of the metal-air battery 200 of FIG. 2. Furthermore, because of the structure, the proportion of zinc utilized when generating power is also increased. The structure of the structured lattice zinc anode 300 can also lead to increased mechanical strength and increase the life of the battery. Each layer of the lattice layer consists of a porous or non-porous substrate such as copper, nickel, aluminum, or a conductive polymer on which zinc is electroplated or sprayed to achieve a zinc thickness of 20 to 60 microns.

An expanded sectional view 310 of the structured lattice zinc anode 300 is also shown to illustrate one example of the structured lattice zinc anode 300. Expanded sectional view 310 includes the copper anode contact 312, which can operate as the current collector for the zinc anode by allowing for the uniform distribution of any charge that is created. The zinc scaffold 314 represents the structured lattice of zinc and is typically in a hexagonal closed-packed lattice structure, which provides both its increased surface area and its improved structural stability. Also, due to the close packing of the zinc in the zinc scaffold 314, the discharge rate of the zinc anode 316 is increased. This structure also allows the capacity to increase via stacking multiple anodes together, separated by an insulator.

In a further embodiment consistent with the present disclosure, in conjunction with or in place of the zinc scaffold 314, the zinc can be coated with a porous or non-porous substrate, e.g., copper, nickel, or a conductive polymer, to create a suitable scaffold for the zinc anode. An additional layer of coating can be added to the anode to minimize zinc dissolution and the hydrogen evolution reaction. The coating can be between 10 and 100 nanometers thick. This nanometer-scale coating prevents the charge and discharge processes from reacting with the anode.

FIG. 4 illustrates an exemplary design of a membrane 402 that is consistent with the present disclosure. The membrane 402 is provided as an example to aid in describing the present technology. Although a particular arrangement of components is depicted in FIG. 4, the arrangement of such components should not be considered limiting of the present technology unless otherwise specified in the appended claims.

In one example of the membrane 402 of FIG. 4, the membrane 402 is a porous membrane with greater than 20% porosity, more preferably greater than 25% porosity, and most preferably greater than 50% porosity. In one exemplary embodiment, the membrane 402 can have an area of 25 cm² and create 200-300 milliamps per cm². The membrane can be less than 400 microns thick, more preferably less than 200 microns thick. Further, if the membrane is created out of PTFE or ePTFE, then the membrane can be as thin as 10 microns and provide a semi-permeable membrane. In a further example consistent with this disclosure, PTFE can be sprayed onto the membrane 402 to allow for changing thicknesses. Another example consistent with the current disclosure is to create the semipermeable membrane 402 out of a binding agent, e.g., PVDF. To increase the surface area of membrane 402, fine conductive particles can be embedded into membrane 402, which will increase the surface area of membrane 402.

One method for improving the porosity of membrane 402 is to utilize 3-D printing technology. 3-D printing the membrane 402 improves the mechanical strength of the membrane, which allows for the lifespan of the membrane to increase. The membrane 402 also has improved hydrogen flux due to the increased porosity, which improves the efficiency of the hydrogenation reaction. 3-D printing the membrane also increases the ease of changing the membrane for different applications. For example, different catalysts can be used for different conditions. It also allows the membrane 402 of FIG. 4 to be coated with a catalyst, carbon, and/or PTFE or ePTFE. Alternatively, the membrane can be constructed out of Faraday's fabric coated with a catalyst and PTFE, a non-woven fabric, or a similar porous membrane that offers a high surface area for the ionization of oxygen and hydrogen ions. An additional bonding layer of PTFE with the membrane is performed either through heat press or through roll-to-roll process, this can also be used with the PTFE and fine particles embodiment to create a tightly bound proper membrane. Furthermore, an additional activated carbon, graphite, or conductive powdered layer may be embedded onto the membrane to increase the surface area either through a powder coating process or through spray coating the membrane.

In a further aspect of the disclosure, the membrane 402 can have the catalyst loaded onto the membrane to form a three-phase boundary between the reactants on the anode and the cathode. However, it should be noted that the catalyst may also be added to the liquid reactant(s) or liquid-gas reactants and fed into the metal-air battery 200 of FIG. 3.

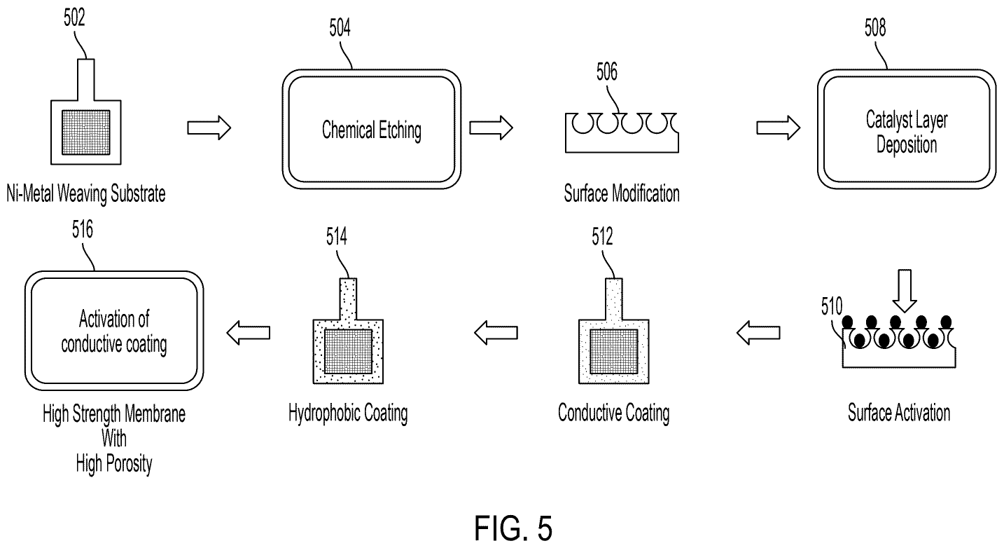

One exemplary process for creating the porous membrane 400 for use in metal-air batteries 100 and 200 is provided in FIG. 5.

FIG. 5 illustrates an exemplary design process 500 of a porous membrane 400 that is consistent with the present disclosure. FIG. 5 is provided as an example to aid in describing the present technology. Although a particular arrangement of components is depicted in FIG. 5, the arrangement of such components should not be considered limiting of the present technology unless otherwise specified in the appended claims.

Initially, at one exemplary step of design process 500, step 502 includes the substrate of the porous membrane 402 of FIG. 4 being a nickel metal substrate that needs to be prepared for the hydrogenation reaction. The nickel metal substrate can be created via 3-D printing or by weaving metal strands together. Some exemplary methods of 3-D printing include metal powder bed fusion, which can include laser melting technology and/or laser sintering. Both of these utilize the underlying metal or alloy, e.g., nickel or nickel alloy, as the basis for building a porous membrane out of the chosen metal.

At a further exemplary step of design process 500, step 504, the nickel metal substrate is chemically etched to prepare the nickel metal substrate for further modification. For example, chemical etching can help improve the porosity of the membrane or the pore sizes used in the membrane. This step can also be used to remove any additional preparatory materials used to make the nickel metal substrate. At exemplary step 506, the surface of the nickel metal substrate can be modified using surface modification procedures. This surface modification can include cleaning the surface of any remaining contaminants and can roughen the surface to make the catalyst deposition more robust.

At exemplary step 508, the catalyst can be embedded into the membrane 402 via a deposition process if the membrane 402 used for the hydrogenation reaction is going to include one of the chosen catalysts, e.g., nickel, titanium, stainless steel, palladium, platinum, iridium oxide, or ruthenium oxide. After the layer of the catalyst is formed, in step 510 the catalyst is activated. This can take place via calcination, reduction, or electrochemical activation. After the catalyst is activated, in exemplary step 512, a conducive coating is added to the membrane 402. Next, in exemplary step 514, a hydrophobic coating is added. For example, PTFE can be added to the membrane. Finally, at exemplary step 516, the conductive coating from step 512 can be activated by electrochemical activation, chemical treatment, or thermal treatment.

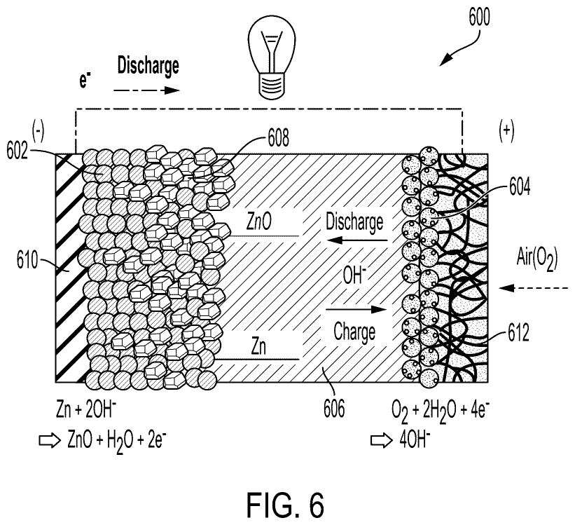

FIG. 6 represents another exemplary embodiment of the present disclosure. FIG. 6 is provided as an example to aid in describing the present technology. Although a particular arrangement of components is depicted in FIG. 6, the arrangement of such components should not be considered limiting of the present technology unless otherwise specified in the appended claims. Furthermore, while the example below is specific to zinc, the membrane technology, fabrication of the anode, and hydrogen/oxygen-based recharging can be applied to metal-air batteries generally, as well as lithium-air, aluminum air, iron-air, and sodium-air batteries, as well as flow batteries utilizing membranes.

The zinc air battery discharge is shown in FIG. 6, where an anode 602 and a cathode 604, in electrolyte 606, create a discharge based on the reaction. In one example of the zinc air battery 600, an anode 602 is zinc, a cathode 604 is air, and the electrolyte is an aqueous mixture of potassium hydroxide. Based on the chemistry described with respect to the reactions below, the discharge process leads to the creation of zinc hydroxide instead of zinc oxide. This has the benefit of creating a passivating layer, e.g., passivating layers 212 or 220, that minimizes the production of dendrites and minimizes dissolution of the zinc anode. For example, the dissolution of the zinc anode into the electrolyte can be reduced by at least three to five times compared to previous zinc implementations. Based on these components, the zinc air battery will operate based on the following reactions.

One exemplary reaction is the anode 602 undergoing a reaction represented by the following reaction equation:

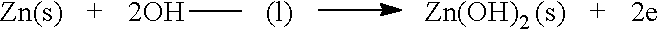

Further, an example reaction for the cathode 604 is represented by the following reaction equation:

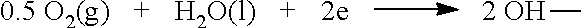

Accordingly, in this example, the overall equation during discharge is:

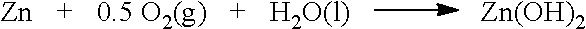

In this example, the E₀ is 1.65V, and the theoretical storage capacity is −1.36 kWh/kg-Zn.

While this specific example is related to zinc, the metal can be a different metal, e.g., lithium, iron, sodium, or aluminum. Furthermore, adding hydrogen gas, in addition to or in place of oxygen, can be beneficial for some use cases.

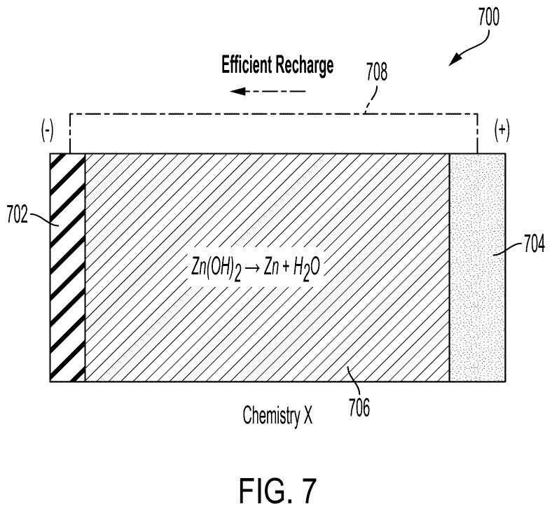

FIG. 7 represents another exemplary embodiment of the present disclosure. FIG. 7 is provided as an example to aid in describing the present technology. Although a particular arrangement of components is depicted in FIG. 7, the arrangement of such components should not be considered limiting of the present technology unless otherwise specified in the appended claims.

FIG. 7 represents the efficient charging of a zinc-air battery consistent with the current disclosure. Charging the zinc air battery 700 of FIG. 7 involves an outside electrical source added to the system, which reverses the discharge process of FIG. 6. For example, during the recharge process, zinc is the cathode, and hydrogen gas is added to the system, which becomes the cathode during recharging. The electrolyte 706 can be, e.g., sodium hydroxide, potassium hydroxide, lithium hydroxide, a solid-state electrolyte, an organic solvent, or calcium hydroxide. When the electrolyte is, e.g., aqueous potassium hydroxide (KOH), the KOH can carry the OH— ions from the cathode 702 to the anode 704. The electrons go through the external electrical circuit to the cell from the anode 704 to the cathode 702.

The reaction taking place is represented by the following reaction equation: In this example, the cathode 702 can undergo the following reaction:

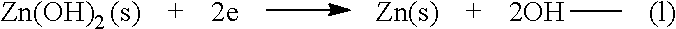

The anode 704 can undergo the following reaction:

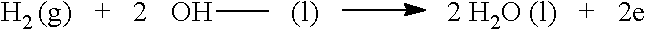

The net reaction during the charge in this example is:

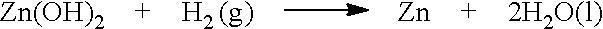

The result of this process is metallic zinc being added back to the electrode and restoring the battery capacity via the reaction equation above. In this example, the E₀ is 7 volts, and the theoretical storage capacity is +0.41 kWh/kg-Zn. This process, the combination of the discharge cycle of FIG. 6 and the charge cycle of FIG. 7 allows for increased capacity and longer-lasting zinc air batteries. Further, the batteries consistent with this disclosure can achieve

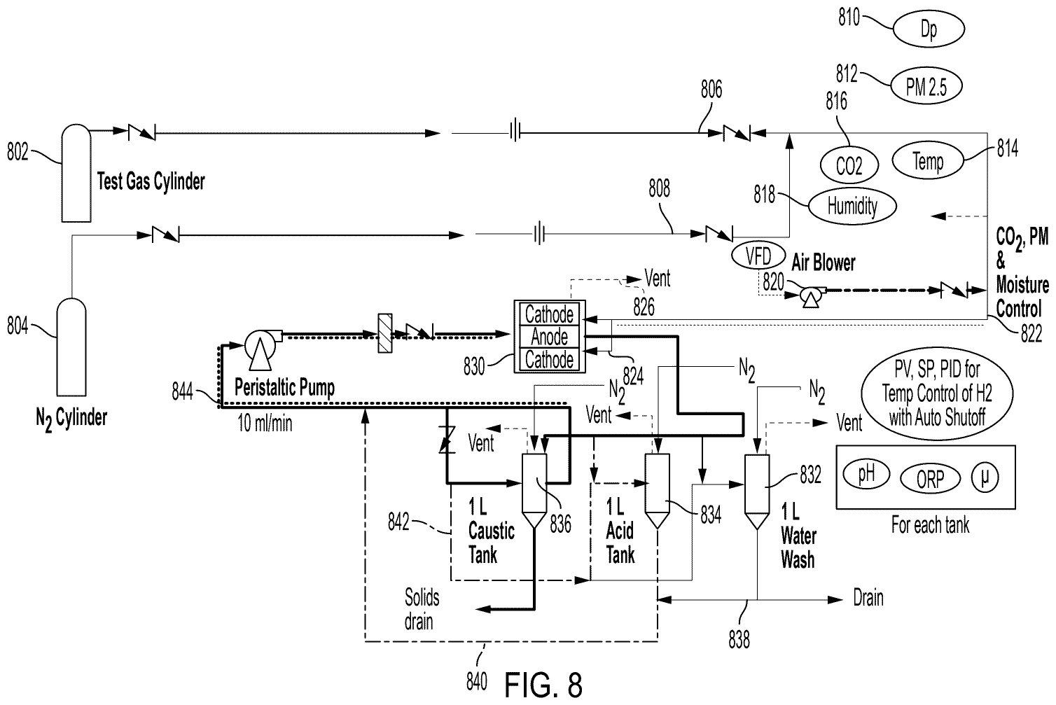

FIG. 8 represents an exemplary embodiment of the present disclosure for testing metal-air batteries. FIG. 8 is provided as an example to aid in describing the present technology. Although a particular arrangement of components is depicted in FIG. 8, the arrangement of such components should not be considered limiting of the present technology unless otherwise specified in the appended claims.

Test environment 800 includes the setup and materials to perform a test under varying real-world conditions to determine the appropriate set for a metal-air battery, like those described FIGS. 1-8. Initially, test gas cylinder 802 and nitrogen cylinder 804 are used to fill the test gas line and the nitrogen gas lines with the test gas and nitrogen, respectively. Each stream can include any combination of a control valve for modulating flow, an XCV valve that can open and close flow through the line, a pressure regulator to regulate the pressure in the line, a motorized valve to control flow in the line, an excess flow valve for safety, a flow alarm to measure if flow is too high or too low, a pressure safety valve to ensure pressure does not exceed a predetermined level. Once the flows are controlled and regulated, they are combined into test gas line 822.

The combined gasses in test gas line 822 can then be tested via sensors adjacent to test gas line 822. For example, the test gas line 822 can have a differential pressure sensor 810, a particulate matter sensor 812, a temperature sensor 814, a CO₂ sensor 816, and a humidity sensor 818, and it is also possible to include smoke and fire sensors in the to determine if there are any emergent conditions that need to be addressed by plant operators. The system also includes an air blower 820 as an additional input into test gas line 822, which allows for the control of carbon dioxide, particulate matter, and moisture in the test environment 800.

Test environment 800 then includes a test battery, which can be a metal-air battery from any embodiment of this disclosure, including metal-air battery 100, power generation unit 980, metal-air battery 200, zinc air battery 600, or zinc air battery 700. The test battery includes an air input from test gas line 822 for the metal-air battery as well as a second input. The second test gas line is 824, and for a second cathode of the test battery, it is 830. Test gas line 822 can be split into an appropriate number of gas lines to correspond to the number of layers needed for the capacity of the battery. The electrolyte for the test battery 830 is then circulated via electrolyte feed line 844 through the anode of test battery 830, creating a recycle loop to create a continuous test process.

The test battery is monitored for performance, so depending on the measurements related to the differential pressure, particulate matter, temperature, CO₂ levels, and humidity levels, it is possible to determine the performance of the battery under specific conditions. The test environment 800 tests for the kilowatt hour, the amps, and the volts output from test battery 830. By tracking these variables, the battery performance can be calculated, and the battery or environment can be changed to optimize performance level.

The electrolyte in electrolyte feed line 844 can be changed as needed depending on the test results and desired changes. To facilitate different concentrations, flow rates, and the ability to alter other variables, the system needs to be neutralized and cleaned. For that reason, the test environment 800 includes both a water tank 832 and an acid tank 834. Because one type of electrolyte is basic, an acid flush can help neutralize the lines and prevent the build-up of contaminants in the system. For this reason, test environment 800 includes acid recycle line 842 line to facilitate an acid flush of the system and any acid-based test that needs to be run on a test battery. Also, to clean out the lines between tests, there is wash line 838, which can be used to clean out the lines used for running the tests.

Accordingly, the testing environment allows the variables to be tested and the performance of the test battery to be tested within different environments to determine the best battery conditions for performance.

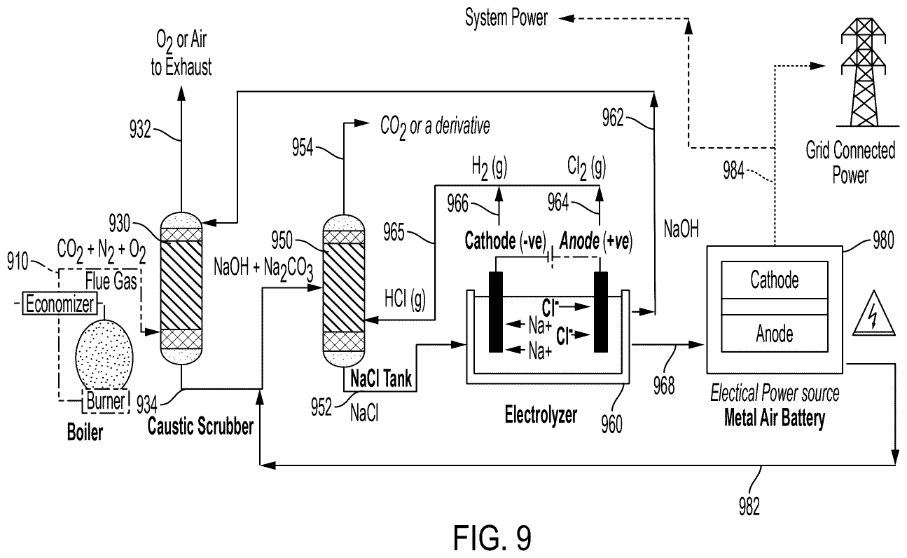

FIG. 9 illustrates a general system for the implementation of a carbon capture system 900. Initially, flue gasses from an industrial source can be fed into the carbon capture system 900 as flue gas stream 910. The flue gases or off gases in flue gas stream 110 include CO₂ and other impurities and can initially be cooled via an interchanger or heat exchanger. The flue gasses can be cooled to between 10° C. and 70° C. If further cooling is needed, the intake process can include a secondary cooler, such as a cooling water exchanger or a glycol cooler. After cooling, the flue gasses can be filtered by, for example, a coalescing filter to remove any oil from the flue gasses. Finally, the flue gases can be fed into a particulate filter, which can be used to remove fine solids in the stream. The removal of fine solids is required to mitigate the risks of hydrogen peroxide dissociation in the subsequent hydrogen peroxide scrubber for SOx and NOx removal. Notably, the dissociation of hydrogen peroxide due to fly ash or fine particulate matter could lead to a potential hydrogen explosion.

The heat that is removed from the input stream using the interchanger and the secondary cooler can be reused within the system to heat other streams within the carbon capture process. For example, sometimes the caustic used in the process will need an elevated temperature, and/or a caustic that needs regeneration will need to be heated. By recycling the heat from the flue gases fed into carbon capture system 900, the environmental impact of the system will be reduced, and the economics of the plant will increase.

The flue gas stream 910 is then fed into the caustic scrubber 230, where the CO₂ from the flue gas stream 110 is removed. In the caustic scrubber 930 the flue gasses, including carbon dioxide, nitrogen and oxygen are contacted with a caustic solution, e.g., sodium hydroxide, potassium hydroxide, or calcium hydroxide, and the CO₂ from the flue gas stream 910 is removed via a reaction with the caustic solution. In the caustic scrubber 230, when the flue gas stream 910 comes into contact with the caustic solution, a reaction occurs between the caustic solution and the carbon dioxide. The reaction will typically take the following form:

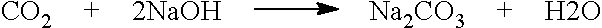

The majority of the carbon dioxide in the flue gasses is captured in the caustic scrubber via the above reaction. The stream that includes NaOH, water, and Na₂CO₃ is diluted and referred to as a lean caustic stream 134 and exits the caustic scrubber 130 through the bottoms product lean caustic stream 934. The distillate 932 is substantially oxygen, nitrogen, and/or carbon monoxide. The distillate 932 can either be further filtered and/or released into the atmosphere.

The lean caustic stream 934 from caustic scrubber 230 can be fed into a neutralization scrubber 150, where the NaOH and Na₂CO₃ are fed into the neutralization scrubber 150 and reacted with hydrochloric acid to form NaCl and water, along with carbon dioxide. The neutralization scrubber 950 is typically operated from about 20° C. to a slightly elevated temperature of 60° C. The remaining CO₂ that is produced by the neutralization scrubber 950 can be released via CO₂ outlet 954 to the environment or further processed, as will be discussed with respect to later implementations of the present disclosure. The NaCl and water are transferred out via the neutralization scrubber bottoms 952 of the neutralization scrubber 950 to an electrolyzer 960 that can create an electrolyte for a power generation unit 980 along with hydrogen gas and chlorine gas for the creation of the hydrochloric acid used in the neutralization scrubber 950.

The electrolyzer 960 receives the NaCl and water from the neutralization scrubber bottoms 952 and undergoes a chloralkali process to form hydrogen gas, chlorine gas, and sodium hydroxide. The electrolyzer 960 passes a current through an aqueous solution that includes the NaCl from the neutralization scrubber 950, and electrolysis separates the ions and produces chlorine gas (Cl₂) 964 through an oxidation reaction at the anode and hydrogen gas (H2) hydrogen gas 966 and sodium hydroxide, through a reduction reaction, at the cathode. The electrolyzer 960 can include a membrane (not shown) to separate the products and facilitate the creation of the products, e.g., sodium hydroxide, hydrogen gas, and chlorine gas.

The hydrogen gas 966 and the chlorine gas 964 can be combined to form hydrochloric acid, HCl stream 965, which can be used in the neutralization scrubber 950 to facilitate the formation of the carbon dioxide for CO₂ outlet 954 and NaCl for the electrolyzer 960. The sodium hydroxide formed in the electrolyzer 960 can be fed via NaOH stream 962 into the caustic scrubber 230 and used to remove the carbon dioxide from the flue gasses. The NaOH stream 962 can be chlorinated by combining it with the chlorine gas 964 from the electrolyzer 960 to additionally create NaOCl, NaCl, and water as byproducts of the reactions. The chlorination reaction will typically be run at low temperatures, e.g., less than 25° C. to prevent the hypochlorite product from decomposing. The NaOH can also be fed into a power generation unit 980 via stream 968, where the power generation unit 980 can utilize the NaOH as an electrolyte for power production in a metal-air battery, which will be discussed in detail below. The power generation unit 980 can be used to power the carbon capture system 900, to provide the power to the grid via power line 984, or both. The NaOH from power generation unit 980 can be recycled into lean caustic stream 934 via recycle stream 982 to improve the overall efficiency of carbon capture system 900.

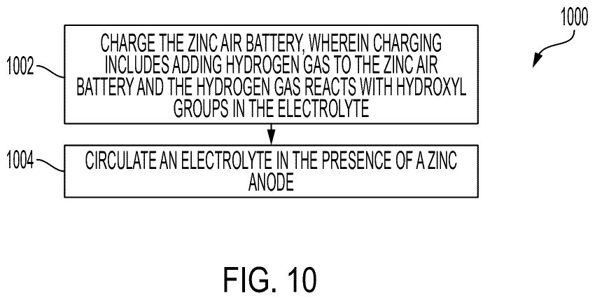

FIG. 10 illustrates an example method for charging the zinc air batteries of FIGS. 1-9. Although the example method depicts a particular sequence of operations, the sequence may be altered without departing from the scope of the present disclosure. For example, some of the operations depicted may be performed in parallel or in a different sequence that does not materially affect the function of the method. Additionally, some of the depicted operations may be optional, and some operations that are not depicted might be part of the method. In other examples, different components of an example device or system that implements the method may perform functions at substantially the same time or in a specific sequence.

In block 1002, routine 1000 charges the zinc air battery, wherein charging includes adding hydrogen gas to the zinc air battery, and the hydrogen gas reacts with hydroxyl groups in the electrolyte. For example, as shown in FIG. 7, the metal-air batteries consistent with the present disclosure can be efficiently recharged. Charging the zinc air battery 700 of FIG. 7 involves an outside electrical source added to the system, which reverses the discharge process of FIG. 6. For example, during the recharge process, zinc is the cathode, and hydrogen gas is added to the system, which becomes the cathode during recharging. The electrolyte 706 of FIG. 7 is aqueous potassium hydroxide and can carry the OH— ions from the cathode 702 to the anode 704. The electrons go through the external electrical circuit to the cell from the cathode 702 to the anode 704.

The reaction taking place during the charging step of block 1002 is represented by the following reaction equation:

In this example, the cathode 702 can undergo the following reaction:

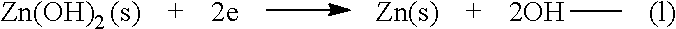

The anode 704 can undergo the following reaction:

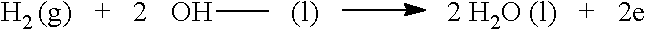

The net reaction during the charge in this example is:

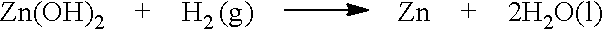

The recharge reaction disclosed above can be followed by a discharge reaction, consistent with the process shown in FIG. 6, where an anode 602 and a cathode 604, in electrolyte 606, create a discharge based on the reaction between the anode 602, cathode 604, and the electrolyte 606. In one example of the zinc air battery 600, an anode 602 is zinc, a cathode 604 is air, and the electrolyte can be an aqueous mixture of potassium hydroxide. Further, the electrolyte can be supplemented with a fire retardant and/or an anode metal base to minimize anode dissolution. One example can be to add zinc to sodium hydroxide to make a sodium zincate-based electrolyte to minimize zinc dissolution. Based on the chemistry described with respect to the reactions below, the discharge process leads to the creation of zinc hydroxide instead of zinc oxide. This has the benefit of creating a passivating layer, e.g., passivating layers 212 or 220, that minimizes the production of dendrites and minimizes the dissolution of the zinc anode. For example, the dissolution of the zinc anode into the electrolyte can be reduced by at least three to five times compared to previous zinc implementations. Based on these components, the zinc-air battery will operate based on the following reactions.

One exemplary discharge reaction consistent with block 1002 is the anode 602 undergoing a reaction represented by the following reaction equation:

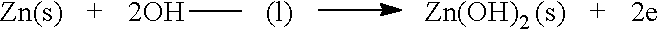

Further, an example reaction for the cathode 604 is represented by the following reaction equation:

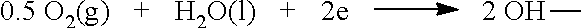

Accordingly, in this example, the overall equation during discharge is:

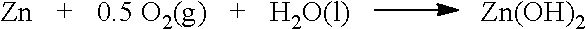

In block 1004, routine 1000 circulates an electrolyte in the presence of a zinc anode. For example, the electrolytes 606 and 706 can be pumped through the metal-air battery so as to create a continuous flow of electrolytes adjacent to the anode 602 of FIG. 6 and anode 704 of FIG. 8. The circulation of the electrolyte allows for both the discharge of the metal-air battery as well as the recharge of the metal-air battery.

During circulation of the electrolyte during discharge, the reaction takes place between the anode and the cathode, resulting in the production of zinc hydroxide on the surface of the zinc anode, e.g., anodes 214 and 218 of FIG. 2, zinc anode 316 of FIG. 3, and anode 602 of FIG. 6. The zinc anodes can be resurfaced or regenerated by washing them with hydrochloric acid, which will dissolve any zinc hydroxide on the surface of an anode.

What is claimed is:

1. A method for recharging a zinc air battery comprising:
charging the zinc air battery, wherein charging includes adding hydrogen gas to the zinc air battery and the hydrogen gas reacts with hydroxyl groups in an electrolyte;
circulating the electrolyte in the presence of a zinc electrode.

2. The method of claim 1, wherein the zinc electrode includes a zinc hydroxide layer on a surface of the zinc electrode.

3. The method of claim 1, further comprising:
after circulating the electrolyte, replacing the electrolyte with a fresh electrolyte, wherein the fresh electrolyte is substantially pure.

4. The method of claim 1, wherein the electrolyte is potassium hydroxide.

5. The method of claim 1, further comprising:
restoring battery capacity by adding metallic zinc to the zinc electrode.

6. The method of claim 5, wherein the electrode potential is about 7 V during recharging.

7. A rechargeable zinc air battery comprising:
a metal electrode;
an air electrode; and
an aqueous electrolyte between the metal electrode and the air electrode, wherein the aqueous electrolyte is potassium hydroxide and the aqueous electrolyte is separated from air electrode by a porous membrane.

8. The rechargeable zinc air battery of claim 7, wherein the porous membrane includes a hydrophobic coating.

9. The rechargeable zinc air battery of claim 7, wherein the porous membrane includes a conductive coating.

10. The rechargeable zinc air battery of claim 7, wherein the porous membrane outputs between 200 milliamps to 300 milliamps per square centimeter of surface area.

11. The rechargeable zinc air battery of claim 7, wherein the porous membrane is less than 400 microns thick.

12. The rechargeable zinc air battery of claim 7, wherein the metal electrode and air electrode form a single cell.

13. The rechargeable zinc air battery of claim 12, further comprising:
a second cell, wherein the second cell includes a second metal electrode and a second air electrode contacting the aqueous electrolyte.

14. The rechargeable zinc air battery of claim 7, wherein the metal electrode is zinc.

15. The rechargeable zinc air battery of claim 14, further comprising:
forming a discharge product of Zn(OH)₂.

16. The rechargeable zinc air battery of claim 15, wherein the Zn(OH)₂ is adjacent to the metal electrode.

17. The rechargeable zinc air battery of claim 7, wherein the rechargeable zinc air battery is integrated into a carbon capture system.

18. The rechargeable zinc air battery of claim 14, wherein the zinc is in a structured lattice configuration.

19. The rechargeable zinc air battery of claim 18, the metal electrode further comprising:
a copper anode contact;
at least one of a zinc scaffold, a porous substrate, or a non-porous substrate; and
a zinc anode, wherein the copper anode is adjacent to the at least one zinc scaffold, porous substrate, or non-porous substrate, and the at least one zinc scaffold, porous substrate, or non-porous substrate is adjacent to the zinc anode.

20. The rechargeable zinc air battery of claim 19, further comprising:
a protective coating on the zinc electrode, wherein the protective coating is less than 100 nanometers thick.
